(19) United States
(12) Patent Application Publication
(10) Pub. No.: US 2010/0024486 A1
(43) Pub. Date: Feb. 4, 2010

(54) METHOD OF PRODUCING OPTICAL FIBER PREFORM

(75) Inventor: Kenji OKADA, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujikura Ltd., Tokyo (JP)

(21) Appl. No.: 12/468,465

(22) Filed: May 19, 2009

(30) Foreign Application Priority Data
Aug. 4, 2008 (JP) 2008-200733

(51) Int. Cl. C03B 37/025

(52) U.S. Cl. 65/435

(57) ABSTRACT

A method of producing an optical fiber preform comprising: performing production of a glass preform having a valid portion to be drawn to an optical fiber and invalid portions disposed to both ends of the valid portion by depositing a porous silica glass body on a periphery of a glass rod; and performing vitrification of the porous silica glass body by heat treating the glass preform, wherein, during the vitrification, at least a portion of the porous silica glass body in the invalid portion of at least one end is dislocated relative to the glass rod along the axial direction of the glass rod such that a stress between the glass rod and the porous silica glass body is relaxed.

### BACKGROUND OF THE INVENTION

1. Field of the Invention

The present invention relates to a method of producing optical fiber preform capable of suppressing cracking, delamination, and slip-dislocation of a glass.

Priority is claimed on Japanese Patent Application No. 2008-200733 filed on Aug. 4, 2008, the content of which is incorporated herein by reference.

2. Description of the Related Art

As a general production method of an optical fiber preform, for example, it is possible to apply the following method. Firstly, a glass rod having a predetermined structure is produced. The structure of the glass rod corresponds to a core of an optical fiber or a core and a clad formed on the core of an optical fiber. Next, a porous glass preform is formed by depositing a porous silica glass (soot) body on the periphery of the glass rod. By heat treating the glass preform, at least a valid portion of the porous silica glass body is vitrified to a transparent glass. In general, the valid portion of the preform is drawn to an optical fiber.

As a method of depositing the porous silica glass body, it is possible to use a so called OVD method (Outside Vapor Deposition Method). In the OVD method, fine silica glass particles are synthesized from a source gas using a burner. While rotating the glass rod and moving the glass rod relative to the burner along the center axis of the glass rod, the synthesized fine glass particles are sprayed to a periphery of the glass rod. Thus, the fine glass particles are deposited in a layered form on the glass rod.

The porous silica glass body may be vitrified, for example, by heating the porous glass preform while moving the glass preform through a heat zone in a heating furnace. In this process, a heated portion changes its position from one end to another end of the porous silica glass body.

Conventionally, in the porous glass preform to be vitrified in the above-described production method, end portions of the porous silica glass body on the glass rod have a tapered shape such that the diameter of the porous glass body gradually decreases towards its tip in the vicinity of the end of the glass preform. The porous silica glass body is given this tapered end shape so as to inhibit its cracking during the vitrification process.

The tapered portions of the porous glass preform, tapered along center axis of the preform are called invalid portions. The portion interposed between the invalid portions is called valid portion. In general, the valid portion is worked to an optical fiber. The invalid portions are used as support portions that support the valid portion during the production process of an optical fiber preform and during the production process of an optical fiber.

However, the state of the porous silica glass body at the center portion along the center axis of the valid portion is different from that of the invalid portion. Therefore, there is a possibility of the occurrence of problematic phenomena. For example, during the vitrification process, cracking or deformation may occur in the valid portion and/or in the invalid portion. In addition, the porous silica glass body or vitrified silica glass may be delaminated from the glass rod.

Various methods are proposed for solving the above-described problems. For example, Patent Reference 1 (Japanese Unexamined Patent Application, First Publication No. H6-239640) discloses a method to inhibit starting of cracks from the invalid portion by decreasing the taper angle of the tapered portion of the porous silica glass body thereby dispersing the stress applied on the tapered portion.

In the method disclosed in Patent Reference 2 (Japanese Unexamined Patent Application, First Publication No. 2006-193370), two ends of a main glass rod that constitutes the valid portion are fusion-bonded to glass rods prepared as dummy rods, where each of the dummy rods has a diameter smaller than that of the main glass rod, and the porous silica glass body is formed to have tapered portions on the peripheries of the dummy rods.

Patent Reference 3 (Japanese Unexamined Patent Application, First Publication No. 2000-159533) discloses a method to inhibit starting of cracks from the invalid portion. In this method, the porous silica glass body on the invalid portion is specifically strongly sintered so as to increase the density of the tapered portion, thereby improving the adhesion of the vitrified silica glass to the glass rod.

However, in the method disclosed in Patent Reference 1, the tapered portion is lengthened by decreasing the taper angle. As a result, it was impossible to apply this method to produce a large-sized optical fiber without increasing the production cost and defect ratio. Recently, there is a trend of increasing the size of the optical fiber preform, especially the diameter of the optical fiber preform with an intention to decrease the production cost of the optical fiber. However, where an optical fiber preform has a large diameter, it is necessary to increase the length of the valid portion in accordance with the increased length of the tapered portion. Therefore, the production apparatus is required to have a large size, resulting in increased cost. In addition, by increasing the length of the tapered portion, the homogeneity and variation ratio of the stress in the invalid portion allowed is limited to narrow range. As a result, the defect ratio is increased.

In the case of simply lengthening the optical fiber preform without increasing its diameter, a large sized apparatus is also required.

The method described in Patent Reference 2 included a problem in that dummy rods were easily deformed where the optical fiber preform had a large diameter. To increase the diameter of the optical fiber preform, it is necessary to increase the diameter of the glass rod. On the other hand, glass rods of small diameters are generally used as the dummy rod. Since mass of the porous silica glass body deposited on the glass rod is many times greater than the mass of the glass rod, dummy rods occasionally fail to support the large mass.

In the method described in Patent Reference 3, various problems occurred where the size of the optical fiber preform was increased. For example, cracking may occur in the valid portion. In addition, it was impossible to inhibit delamination of the vitrified silica glass from the glass rod and/or dislocation of the vitrified silica glass. Where the optical fiber preform has an increased size, shrinkage stress of the porous silica glass body during the vitrification process is larger than in a conventional case. Even in this case, generation of cracks starting from the invalid portion may be inhibited by strongly sintering the tapered portion. However, the valid portion tends to deform if the adhesion of the glass rod and the vitrified silica glass is relatively small.

As explained above, there has been no effective method that could stably produce large-sized optical fiber preforms while inhibiting cracking, delamination, dislocation or the like of a glass of the preform.

Based on the consideration of the above-described circumstances, an object of the present invention is to provide a method of producing an optical fiber preform that can be applied to a production of a large-sized optical fiber preform by an outside deposition method such as OVD method and enables vitrification of the porous silica glass body while avoiding cracking, delamination, dislocation or the like of the glass in the valid portion.

### SUMMARY OF THE INVENTION

A method of producing an optical fiber preform according to the present invention includes: performing production of a glass preform (porous glass preform) having a valid portion to be worked to an optical fiber and invalid portions adjacent both ends of the valid portion by depositing a porous silica glass body on a periphery of a glass rod; and performing vitrification of the porous silica glass body by heat treating the glass preform, wherein, during the vitrification, at least a portion of the porous silica glass body in the invalid portion of at least one end is dislocated relative to the glass rod along the axial direction of the glass rod such that the stress between the glass rod and the porous silica glass body is relaxed (reduced).

In the above-described method of producing an optical fiber preform, it is preferable to dislocate the porous silica glass body to be vitrified by controlling a deposition condition of the porous silica glass body and/or a vitrification condition to vitrify the porous silica glass body to a transparent glass.

In the above-described method of producing an optical fiber, it is preferable to perform heat treatment of the glass preform during the vitrification by using a zone heating furnace equipped with a heater and moving the glass preform in the axial direction thereof relative to the heater, wherein in the time of starting the heat treatment, a tip (end) of an invalid portion on the side of the moving direction of the glass preform is placed within 25% or less of a length of the heater from the center of the heater along the moving direction.

In the above-described method of producing an optical fiber preform, it is preferable to perform heat treatment of the glass preform during the vitrification by using a zone heating furnace equipped with a heater and moving the glass preform in the axial direction thereof relative to the heater, wherein, in the time of starting the heat treatment, a tip of the invalid portion of at least one end is placed at a position projecting with a length of longer than 0 cm and not longer than 5 cm from the end of the heater along the axial direction of the glass rod.

In the above-described method of producing an optical fiber preform, it is preferable that the adhesion between the porous silica glass body and the glass rod at their interface in the invalid portion of at least one end is made smaller than the adhesion between the porous silica glass body and the glass rod at their interface in the valid portion.

Preferably, in the above-described method of producing an optical fiber preform, the porous silica glass body is formed by layering a plurality of soot layers, and the adhesion between the porous silica glass body and the glass rod at their interface in the invalid portion of at least one end is made smaller than the interlayer adhesion of the soot layers.

Preferably, in the production of the glass preform in the above-described method of producing an optical fiber preform, the porous silica glass body is formed to have a normal portion having a predetermined adhesion to the glass rod and at least a low-adhesion portion where the adhesion of the porous silica glass body to the glass rod is smaller than that of the normal portion by decreasing the deposition temperature of the porous silica glass body at the low adhesion portion.

In the above-described method of producing an optical fiber preform, it is preferable to control a difference of the deposition temperature of the low adhesion portion from a deposition temperature of the normal portion to be −5 to −50° C.

Preferably, in the method of producing an optical fiber preform according to the present invention, the porous silica glass body has a tapered shape in the invalid portion of at least one end such that outer diameter of the porous silica glass body gradually decreases along the axial direction towards the tip of the porous silica glass body.

In the above-described method of producing an optical fiber preform, it is preferable to control a dimension c of dislocation of the porous silica glass body to be vitrified in the invalid portion to be in the range given by a formula, 0.5b/a≦c≦5b/a, where a is a length of the tapered portion along the axial direction, and b is the diameter of the glass rod in the valid portion.

The present invention can be applied to production of large-sized optical fiber preforms by an outside deposition method such as an OVD method. It is possible to vitrify the porous silica glass body without causing cracking, delamination, dislocation or the like of the glass in the valid portion. In addition, it is possible to produce large sized optical fiber preforms stably using a conventional appliance. Therefore, it is possible to provide inexpensive optical fibers of high quality.

### BRIEF EXPLANATION OF DRAWINGS

FIG. 1 is a schematic vertical cross section diagram exemplifying a glass preform.

FIG. 2A is a schematic vertical cross section diagram of an optical interfacial fiber preform obtained from a glass preform in which interfacial adhesion in the invalid portion is smaller than the interfacial adhesion in the valid portion.

FIG. 2B is a schematic vertical cross section diagram of an optical interfacial fiber preform obtained from a glass preform in which interfacial adhesion in the invalid portion is the same or larger than the interfacial adhesion of the valid portion.

FIG. 3A is a schematic vertical cross section diagram exemplifying an arrangement of a glass preform in a zone heating furnace in the time of starting the heat treatment in the vitrification according to the present invention, and shows a state at which a tip of the second invalid portion is placed higher (upper) than the center position of the heater with a distance of 25% of the length of the heater.

FIG. 3B is a schematic vertical cross section diagram exemplifying an arrangement of a glass preform in a zone heating furnace in the beginning of the heat treatment in the vitrification according to the present invention, and shows a state at which a tip of the second invalid portion is placed upper than the center position of the heater with a distance exceeding 25% of the length of the heater length.

FIG. 3C is a schematic vertical cross section diagram exemplifying of the heat treatment in the vitrification according to the present invention, and shows a state at which a tip of the second invalid portion is placed lower than the center position of the heater with a distance exceeding 25% of heater length.

FIG. 4 is a schematic vertical cross section diagram showing another example of an arrangement of a glass preform in a zone heating furnace of the present invention in the beginning of the heat treatment.

FIG. 5A is a schematic vertical cross section diagram exemplifying an arrangement of a glass preform in a homogeneous heating furnace in the beginning of the heat treatment in the vitrification according to the present invention, and shows a state at which the end portion of the second invalid portion projects from the end of the heater with a length larger than 0.

FIG. 5B is a schematic vertical cross section diagram exemplifying an arrangement of a glass preform in a homogeneous heating furnace in the time of starting the heat treatment in the vitrification according to the present invention, and shows a state at which the end portion of the second invalid portion is placed higher than the lower end of the heater.

FIG. 5C is a schematic vertical cross section diagram exemplifying an arrangement of a glass preform in a homogeneous heating furnace in the beginning of the heat treatment in the vitrification according to the present invention, and shows a state at which the end portion of the second invalid portion projects from the lower end of the heater with a length exceeding 5 cm.

FIG. 6 is a schematic vertical cross section diagram showing another example of an arrangement of a glass preform in a homogeneous heating furnace of the present invention in the beginning of the heat treatment.

FIG. 7 is a schematic vertical cross section diagram showing another example of an arrangement of a glass preform in a homogeneous heating furnace of the present invention in the beginning of the heat treatment.

### PREFERRED EMBODIMENT

In the following, the present invention is explained in detail with reference to the drawings.

### Method of Producing an Optical Fiber Preform

A method of producing an optical fiber preform according to the present invention comprises: performing production of a glass preform (porous glass preform) having a valid portion to be worked to an optical fiber and invalid portion adjacent to both ends of the valid portion by depositing a porous silica glass body on a periphery of a glass rod; and performing vitrification of the porous silica glass body by heat treating the glass preform, wherein, during the vitrification, at least a portion of the porous silica glass body to be vitrified in the invalid portion of at least one end is dislocated relative to the glass rod along the axial direction of the glass rod such that a stress between the glass rod and the porous silica glass body is relaxed (reduced).

The porous silica glass body to be vitrified denotes a glass body in any state from a porous state to a transparent state during the process of vitrification by the heat treatment. In the description of the present invention, where not specifically defined, the porous silica glass body on the process of vitrification is also referred to as a porous silica glass body.

Where not specifically defined, a glass rod on a process of vitrification of surrounding porous silica glass is also referred to as a glass rod.

Dislocation of the position denotes a change (movement) of relative position between the porous silica glass body on a vitrification process and a glass rod at their interface. Where not specifically defined, the position of a predetermined portion of the porous silica glass body relative to the glass rod is changed along the axial direction of the glass rod.

In the present invention, the glass rod is used as a core member to be deposited with the porous silica glass body by an outside deposition method such as a general OVD method. In the production of the optical fiber preform, the main body of the glass rod is constituted of a glass rod having a structure that corresponds to a core of an optical fiber or a core-clad structure of an optical fiber where a clad is formed on the periphery of the core. It is possible to use a generally known glass rod. The glass rod may be produced by a known method such as a VAD method, a CVD method, or an OVD method.

The above-described glass rod, as it is, having a structure corresponding to an optical fiber may be subjected to the deposition of porous silica glass body on the periphery thereof. Alternatively, it is possible to use a glass rod comprising a glass rod main body (first glass rod) having a structure corresponding to an optical fiber, and second and third glass rods fusion-bonded as dummy rods to both ends of the glass rod main body. A glass rod used as a dummy rod may be selected from glass rods generally used in a production of an optical fiber. A diameter of the dummy rod is controlled depending on the size of a desired optical fiber preform to provide a sufficient strength. By using the above-described glass rod including the dummy rods, most of the glass rod main body fusion bonded with the dummy rods can be used to constitute the valid portion. In the present invention, the glass rod includes such a glass rod having dummy rods fusion-bonded to a glass rod main body.

As a method for causing the above-described dislocation (for example, slip, sliding) of the position of the silica glass main body, for example, it is possible to apply method A or method B described below.

The method A controls a deposition condition of the porous silica glass body during the production of the glass preform.

The method B controls a vitrification condition of the porous silica glass body during vitrification of the glass preform.

By applying the above-described methods, it is possible to produce an optical fiber preform using a conventional production appliance without introducing an additional specific process.

Therefore, a desired optical fiber preform to be worked to an optical fiber of excellent optical properties can be produced easily and at low cost. The above-described method A and method B may be applied independently, or may be applied in combination.

During the vitrification, the porous silica glass body has a large shrinkage stress since the porous silica glass body tends to decrease its volume by the vitrification. On the other hand, the shrinkage stress is small in the glass rod. In other words, the glass rod may has an expansion stress by the heating. A stress caused by the difference in the shrinkage stress is generated between the porous silica glass body to be vitrified and the glass rod. However, as described-above, by dislocating the position, the generated stress is relaxed, at least partially, at the portion where the porous glass body is dislocated from the glass rod. As a result, cracking and deformation of the glass preform can be inhibited in the valid portion as well as in the invalid portions. In addition, it is possible to suppress a delamination of a glass layer constituted of vitrified porous silica glass body from the glass rod. Therefore, it is possible to stably produce an optical fiber preform.

In the following, individual steps of the present invention are explained in more detail.

### Production of a Glass Preform.

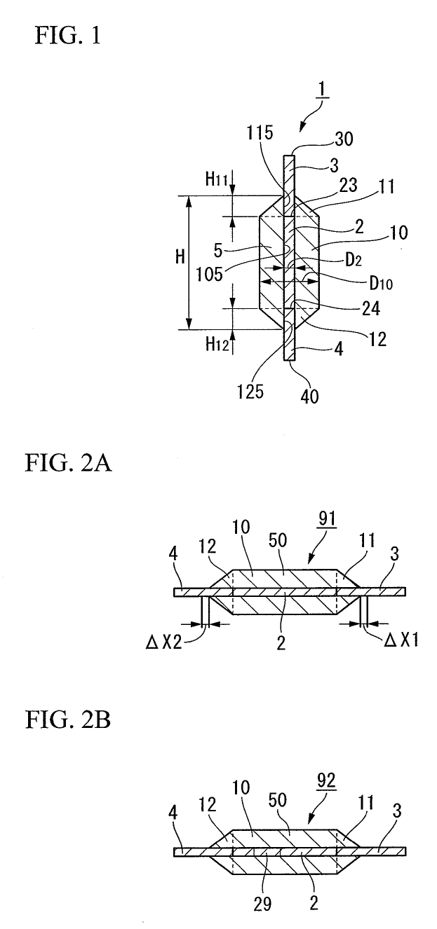

A generally known method may be applied to the production of a glass preform. For example, the glass preform may be produced by setting the glass rod in a porous silica glass body deposition apparatus, synthesizing fine glass particles from a source gas using a burner, and depositing the fine glass particles on the periphery of the glass rod. As the method of depositing the fine glass particles, it is possible to use a soot deposition method such as a VAD method, OVD method, or the like. A schematic vertical cross section of the thus prepared porous glass preform is shown in FIG. 1.

In the glass preform 1 shown in FIG. 1, a first dummy rod 3 (second glass rod) having a diameter D₃ is fusion-bonded to one end of a glass rod 2 (first glass rod: glass rod main body) having a diameter D₂, and a second dummy rod 4 (third glass rod) is fusion-bonded to another end of the glass rod 2. A porous silica glass body 5 is continuously deposited on a whole periphery of the glass rod 2 and on the peripheries of the first dummy rod 3 and the second dummy rod 4, at least in the vicinities to the glass rod 2.

Along the axial direction of the glass rod 2 from the periphery of bonding position (first bonding position) of the glass rod 2 and the first dummy rod 3 towards the tip end 30 of the first dummy rod 3, the porous silica glass body 5 is formed to have a tapered shape having a diameter which gradually decreases towards the tip end 30. Similarly, from the periphery of a bonding position 24 (second bonding position) of the glass rod 2 and the second dummy rod 4 towards the tip end 40 of the second dummy rod 4, the porous silica glass body 5 is formed to have a tapered shape having a diameter gradually decreasing towards the tip end 40. The method of forming the tapered portion of the porous silica glass body 5 is not limited and it is possible to use a known method. Preferably, the above-described two tapered portions are formed to have similar shapes. On the periphery of the glass rod 2, the porous silica glass body 5 has substantially a constant diameter along the axial direction of the glass rod 2. H denotes the length of the porous silica glass body 5 along the axial direction of the glass rod.

Preferably, the glass rod 2, the first dummy rod 3, the second dummy rod 4, and the porous silica glass body 5 are arranged concentrically.

The portion of the glass preform 1 having a porous silica glass body 5 tapered along the axial direction on the periphery of the first dummy rod 3 is a first invalid portion 11. The portion of the glass preform 1 having a porous silica glass body 5 tapered along the axial direction on the periphery of the second dummy rod 4 is a second invalid portion 12. In FIG. 1, H is a predetermined length of the porous silica glass body 5 along the axial direction, H₁₁ is a predetermined length of the first invalid 11 portion along the axial direction, and H₁₂ is a predetermined length of the second invalid 12 portion along the axial direction. In the glass preform 1, a portion between the first invalid portion 11 and the second invalid portion 12 is a valid portion 10 having a diameter D10. The valid portion 10 is a portion that is worked to an optical fiber preform and subsequently drawn to an optical fiber.

As described above, the portions of the glass preform 1 in the vicinity of the both ends of the porous silica glass body 5 are the first invalid portion 11 and the second invalid portion 12 in each of which the porous silica glass body has a tapered shape. Although, the tapered shape is not an inevitable requirement for the invalid portion, the invalid portion preferably has a tapered shape. Where the outer shape has a tapered shape, it is possible to obtain a high effect of inhibiting cracking of the glass preform 1. The porous silica glass body 5 may have a tapered shape at a partial portion of the invalid portion. Preferably, the porous silica glass body 5 is tapered throughout the whole invalid portion. Only one of the two invalid portions (first invalid portion 11 or second invalid portion 12) may have a tapered shape. Preferably, both of the invalid portions (first invalid portion 11 and second invalid portion 12) have tapered shapes.

In FIG. 1, symbol 105 denotes an interface (valid portion interface) between the porous silica glass body 5 and the glass rod 2 in the valid portion 10. Symbol 115 denotes an interface (first invalid portion interface) between the porous silica glass body 5 and the first dummy rod 3. Symbol 125 denotes an interface (second invalid portion interface) between the porous silica glass body 5 and the second dummy rod 4.

### Method A: Controlling Deposition Conditions of a Porous Silica Glass Body

As described above, by applying the method A and controlling deposition conditions of the porous silica glass body in the production process of the glass preform, it is possible to dislocate a predetermined portion of the porous silica glass body relative to the glass rod in the vitrification process as a subsequent process. For example, as the method A, it is possible to use a method in which adhesion between the porous silica glass body and the glass rod in the invalid portion of one end (side) or both ends is made smaller than the adhesion between the porous silica glass body and the glass rod in the valid portion.

More specifically, in one or both of the invalid portions selected from the first invalid portion 115 and the second invalid portion 125, adhesion at the interface between the porous silica glass body and the glass rod (interfacial adhesion in the invalid portion) may be made smaller than the adhesion at the interface 105 of the valid portion (interfacial adhesion in the valid portion).

As described above, the glass rod 2, the first dummy rod 3, and the second dummy rod 4 have small shrinkage stress, while the porous silica glass body 5 has large shrinkage stress. Therefore, by making the interfacial adhesion in the invalid portion smaller than the interfacial adhesion in the valid portion, it is possible to dislocate at least a partial portion of the porous silica glass body 5 relative to the glass rod 2 in the invalid portion at the time of performing vitrification. FIGS. 2A and 2B are vertical schematic cross section diagrams exemplifying the optical fiber preforms. FIG. 2A shows an optical fiber preform obtained from a glass preform where the interfacial adhesion in the invalid portion is smaller than the interfacial adhesion in the valid portion.

FIG. 2B shows an optical fiber preform obtained from a glass preform where the interfacial adhesion in the invalid portion is the same or larger than the interfacial adhesion in the valid portion.

In each of FIGS. 2A and 2B, symbol 50 denotes a transparent glass generated by heat treatment of the porous silica glass body 5.

FIG. 2A exemplifies an optical fiber preform 91 that is obtained where the interfacial adhesions in both of the first invalid portion 11 and the second invalid portion 12 are made smaller than the interfacial adhesion in the valid portion 10. In the first invalid portion 11, the transparent glass 50 is dislocated with a slip length of ΔX₁ relative to the first dummy rod 3. In the second invalid portion 12, the transparent glass 50 is dislocated with a slip length of ΔX₂ relative to the second dummy rod 4.

By generation of such a dislocation, the stress in the interface between the transparent glass 50 and the glass rod 2 is relaxed, and cracking, delamination, dislocation, and the like in the valid portion are suppressed.

On the other hand, in an optical fiber preform that is obtained where the interfacial adhesions in both of the first invalid portion 11 and the second invalid portion 12 are the same or larger than the interfacial adhesion in the valid portion 10, the stress is not relaxed. Therefore, as in the optical fiber preform 92 shown in FIG. 2B as an example, cracking, delamination, dislocation or the like of the glass may occur not only in the invalid portion but also in the valid portion 10. For example, spiral dislocation 29 may occur in the glass rod 2. Such cracking, delamination, dislocation or the like may occur in different portions among different glass preforms. Therefore, their occurrence has a large influence on the productivity of the optical fiber preform, and occasionally resulting in a yield of 50% or less.

In general, a porous silica glass body 5 is formed by layering a plurality of porous silica glass layers (soot layers). In the method A, it is more preferable that the adhesion between the porous silica glass body and the glass rod at their interface is made smaller than interlayer adhesion of the porous silica glass layers of the porous silica glass body in one or both of the invalid portions. Preferably, the adhesion between the porous silica glass body and the glass rod at their interface is made smaller than interlayer adhesion of the porous silica glass layers in the radial section of the glass preform.

Specifically, interfacial adhesion in one or both of the first invalid portion 11 and the second invalid portion 12 is made smaller than interlayer adhesion of the porous silica layers. Such an adhesion is preferably realized in a radial section of the glass preform 1.

By the above-described control of the adhesion, shrinkage stress in the invalid portion is concentrated in the interface between the porous silica glass body and the glass rod. Therefore, cracking, delamination, dislocation or the like of the glass are suppressed in the valid portion as well as in the invalid portion.

The interfacial adhesion in the invalid portion may be made smaller than the interfacial adhesion in the valid portion in only one invalid portion selected from the first invalid portion 11 and the second invalid portion 12. So as to obtain an optical fiber preform of more satisfactory properties, the above described control of the adhesion is preferably performed in both invalid portions.

It is also preferable that the interfacial adhesion in the invalid portion may be made smaller than the interlayer adhesion of porous silica layers in the invalid portion both of the first invalid portion 11 and the second invalid portion 12.

The control of the adhesion may be performed by controlling the formation conditions of the porous silica glass body 5 on the periphery of the glass rod 2, the first dummy rod 3, and the second dummy rod 4.

For example, the above-described formation conditions may be controlled by controlling the deposition conditions of the porous silica glass body. For example, deposition conditions can be controlled satisfactorily by controlling the moving speed of a burner (not shown), the rotation rate of the glass rod 2 or the like. However, in accordance with the above-described cases, control of a burner unit may be required. Therefore, it is more preferable to control the formation conditions of the porous silica glass body 5 by controlling the deposition temperature of the porous silica glass body 5. In this case, it is possible to form the porous silica glass body by a simple process. By simplifying the control, it is possible to ensure the control of the interfacial adhesion in the invalid portion.

Therefore, by controlling the deposition temperature, it is possible to obtain a glass preform 1 of further excellent properties. The deposition temperature can be controlled by controlling flow rates of oxygen gas (O₂) and hydrogen gas (H₂).

Preferably, in the above-described production of the glass preform, the porous silica glass body is formed to have a normal portion having a predetermined adhesion to the glass rod and at least a low adhesion portion where the adhesion to the glass rod is smaller than that of the normal portion by decreasing the deposition temperature of the porous silica glass body at the low adhesion portion. In this case, it is preferable to control the difference between the deposition temperature of the low adhesion portion and the deposition temperature of the normal portion to be from −5 to −50° C. That is, it is preferable to deposit the low adhesion portion at a temperature of 5 to 50° C. lower than the deposition temperature of the normal portion. By using such a range, it is possible to ensure the control of interfacial adhesion of the invalid portion. Where the above-described temperature difference is less than −5° C., there is a case in which cracking, delamination, dislocation or the like of the glass in the invalid portion or in the valid portion cannot be suppressed effectively. Where the above-described temperature difference exceeds −50° C., there is a case in which density depending on the deposition temperature is largely reduced and cracking in the porous silica glass body 5 may occur.

### Vitrification Process.

The glass preform (porous glass preform) obtained by the production of the glass preform is subjected to a heat treatment to vitrify the deposited porous silica glass body to a transparent glass. Heat treatment of the glass preform may be performed by placing the glass preform in the heating furnace at a predetermined position relative to a heater, and moving the glass preform in the axial direction of the glass rod. It is possible to apply a generally known heat treatment method to the above-described treatment.

In the vitrification process, the deposited porous silica glass body is gradually converted to a transparent glass. In the present invention, during the vitrification, at least a portion of the invalid portion of the porous silica glass body on the process of vitrification is dislocated relative to the glass rod along the axial direction of the glass rod.

The above-described dislocation may be performed on one of two invalid portions (in FIG. 1, the first invalid portion 11 and the second invalid portion 12), or on both invalid portions. During the vitrification, the porous silica glass body may be dislocated throughout the invalid portion, or in a partial portion of the invalid portion.

### Method B: Controlling an Arrangement of a Glass Preform in the Vitrification Process

As described above, by applying the method B in the vitrification process, it is possible to dislocate a predetermined portion of the porous silica glass body relative to the glass rod.

Specifically, as an example of method B, it is possible to use a method to place an invalid portion of the glass preform at a predetermined position relative to the heater used in the heating in the beginning of the heating.

In general, the heater has a maximum temperature in its center portion and the temperature of the heater gradually decreases in areas increasingly far from the centre portion. In a heating furnace equipped with a heat insulating member, heating temperature shows more or less variable distribution depending on the shape of the heat insulating member. However, within 25% or less of the length of the heater from the center of the heater, the temperature difference is within 20%. Therefore, the above-described region can be regarded substantially at a maximum temperature state in the heating furnace. On the other hand, a degree of vitrification can be expressed by a function of heating temperature×duration of heating×a value expressing a state of a porous silica glass body (e.g., outer diameter, and density). For example, as the heating temperature is low, long time heating is required to vitrify the porous silica glass body. As the heating temperature is high, the porous silica glass body is vitrified by a short amount of heating. Therefore, in the actual heating furnace, the degree of vitrification of the glass preform is influenced by the temperature distribution of the heater and the time of passing the heated region.

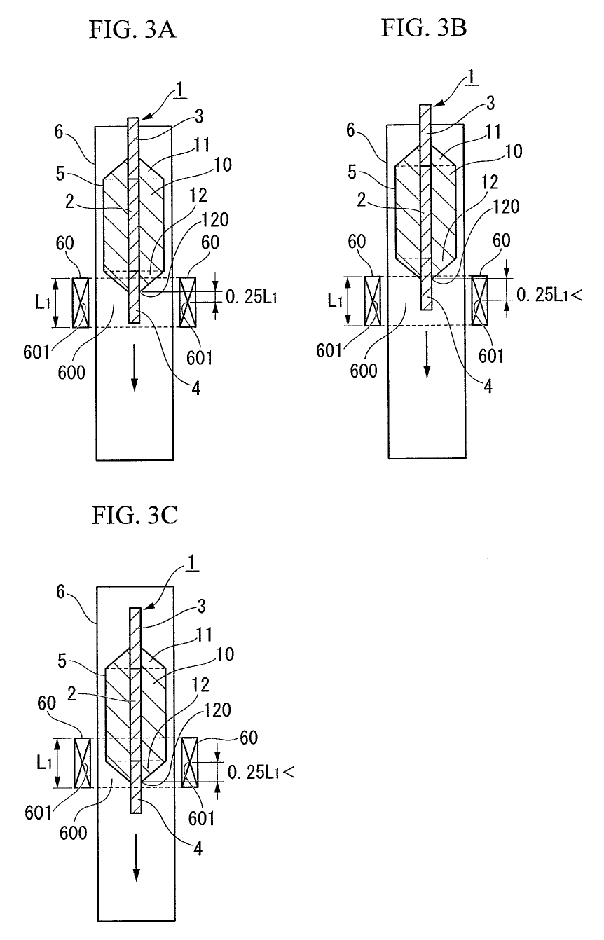

Based on the consideration on the above-described behavior of vitrification, in the present application, in the beginning of the heat treatment, the tip of an invalid portion on the side of the moving direction of the glass preform is preferably placed along the moving direction within 25% or less of the length of the heater from the center (center of the length) of the heater. The tip end position of the invalid portion is substantially similar to the end position of the porous silica glass body in the invalid portion. An example of such an arrangement is shown in FIGS. 3A, 3B, and 3C. FIGS. 3A, 3B, and 3C are schematic cross section diagrams showing an arrangement of a glass preform 1 in a zone heating furnace 6 in the beginning of the heating in the vitrification process. “Zone heating furnace” denotes a furnace in which a material to be heated is heat treated by passing through a heating region provided in a partial region in the heating furnace.

As shown in FIG. 3A, a heater 60 is provided so as to surround a predetermined region in the zone heating furnace 6. The zone heating furnace 6 is constituted such that the glass preform 1 can move along the center axis of the glass rod 2 towards the lower direction (direction shown by the arrow) in a region (main heating region) 600 surrounded by the heater 60. The heater 60 has a length L₁ along the moving direction of the glass preform 1. Symbol 601 denotes a center portion (center in length) of the heater 60. Along the moving direction, tip end 120 of the second invalid portion 12 is preferably set at a position higher than the center position 601 of the heater within 0.25L₁ from the center position 601. In FIG., 3A, as an example of such an arrangement, the tip end 120 is placed 0.25 L1 higher than the center position 601 of the heater, that is, the highest position in the preferable range.

In this state, heating of glass preform 1 is started, and the glass preform 1 is moved lower (lifted down). During this process, the porous silica glass body 5 in the second invalid portion 12 is firstly heated at the highest temperature. The porous silica glass body 5 heated from its surface is gradually vitrified from the surface of the glass preform towards inner radial direction. The tip end 120 is withdrawn from the main heating region 600 before the completion of vitrification of a radial-innermost portion (the boundary portion between the second dummy rod and the porous silica glass body 5) of the porous silica glass body 5 in the second invalid portion.

Above-described control of the vitrification, at least a portion of the porous silica glass body 5 in the second invalid portion 12 can be dislocated compared to the second dummy rod 4 by the effect of shrinkage stress during the vitrification of the porous silica glass body 5. As a result, a vitrified layer is dislocated and the stress is relaxed.

When the first invalid portion 11 moves in the main heating region 600, the porous silica glass body 5 in the first invalid portion 11 is mainly heated from the surface thereof as in the second invalid portion 12, and is gradually vitrified from the surface inwards. As a result, at least a portion of the porous silica glass body 5 is dislocated compared with the first dummy rod 3, and a stress is relaxed by the dislocation.

By thus generating a relaxation of stress, it is possible to suppress cracking, delamination, dislocation and the like of glass in the valid portion 10. Where the tip end 120 of the second invalid portion 12 is disposed above the center portion 601 of the heater at a distance exceeding 0.25 L₁ along the moving direction as shown in FIG. 3B, during the process of moving the glass preform 1 towards lower direction, the porous silica glass body 5 in the second invalid portion is heated not only from the surface thereof but also from the tip end 120. In this case, the porous silica glass body 5 is not gradually vitrified to a transparent glass from its surface towards radial inner direction. There is a case in which the innermost portion in the vicinity to the boundary between the second dummy rod 4 and the porous silica glass body 5 is vitrified in an early stage after the beginning of the heating, and occasionally in the first stage thereafter. In this case, it is difficult to make the porous silica glass body 5 dislocate compared with the position of the second dummy rod 4. Where the dislocation does not occur, stress is not relaxed. Therefore, cracking, delamination, dislocation of the glass may occur not only in the second invalid portion, but also in the valid portion 10.

Where the tip end 120 of the second invalid portion 12 is disposed below the center portion 601 of the heater with a distance exceeding 0.25 L₁ along the moving direction as shown in FIG. 3C, during the process of moving the glass preform 1 downwards, the porous silica glass body 5 may be imperfectly vitrified not only in the second invalid portion 12, but also in the valid portion 10. Such a case is not desirable since the yield of the optical fiber preform thereby is deteriorated.

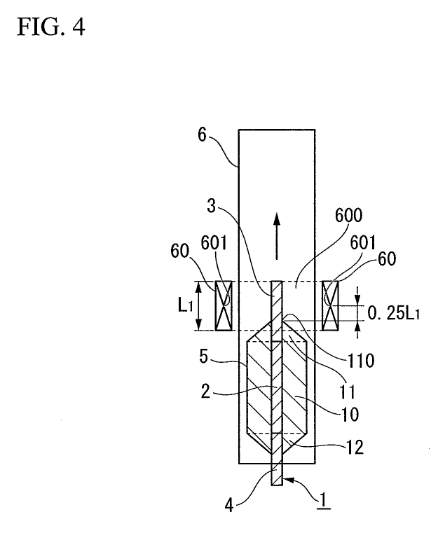

In the above-description, explanation was made with respect to the case of moving (lifting down) the glass preform 1 downwards with reference to FIGS. 3A, 3B, and 3C. Also in the case of moving (lifting up) the glass preform 1 towards the upper direction, stress may be relaxed in the similar manner. FIGS. 4A, 4B, and 4C are schematic cross section diagrams exemplifying the arrangement of the glass preform in the zone heating furnace 6 for the latter case.

In the case of heating the glass preform while moving the glass preform 1 towards the upper direction, it is preferable to place the tip end 110 lower than the center position 601 of the heater at a distance of 0.25L₁ or less. In FIG. 4A, as an example of such an arrangement, the tip end 110 is placed lower than the center position 601 of the heater at a distance of 0.25L1, that is, the lowest position in the preferable range.

Where the heating of the glass preform 1 is started in this state, during the process of moving the glass preform towards the upper direction, the porous silica glass body 5 is heated mainly from its surface and gradually vitrified to a clear glass from the surface towards the radial inner direction.

In the first invalid portion, before completion of vitrifying the radial innermost portion of porous silica glass body 5 in the vicinity to the boundary between the first dummy rod 3 and the porous silica glass body 5, the tip end 110 is separated from the main heating region 600. By the thus controlling the vitrification process, by the influence of shrinkage stress of the porous silica glass body 5 under vitrification, it is possible to dislocate at least a portion of the porous silica glass body 5 compared to the first dummy rod 3 in the first invalid portion 11. By this effect, stress is relaxed.

During the process of moving the second invalid portion 12 in the main heating region 600, the porous silica glass body is heated from its surface in the second invalid portion 12. By the heating from its surface, the porous silica glass body 5 is gradually vitrified to a transparent glass from its surface towards radially inner direction. Therefore, in the second invalid portion 12, at least a portion of the porous silica glass body 5 is dislocated compared to the second dummy rod 4, and the stress is relaxed by this dislocation.

Thus, by causing relaxation of stress to occur, it is possible to suppress cracking, delamination, dislocation and the like of the glass in the valid portion 10.

On the other hand, where the tip end 110 of the second invalid portion 11 is disposed below the center portion 601 of the heater at a distance exceeding 0.25 L₁ along the moving direction (drawing is not shown), during the process of moving the glass preform 1 upwards, the porous silica glass body 5 in the first invalid portion 11 is heated not only from its surface but also from the tip end 110. There is a case in which the innermost portion in the vicinity to the boundary between the second dummy rod 4 and the porous silica glass body 5 is vitrified in an early stage after the beginning of the heating, and occasionally in the first stage thereafter. In this case, as explained in FIG. 3B, it is difficult to make the porous silica glass body 5 to dislocate compared with the position of the second dummy rod 3 in the first invalid portion 11.

Where the tip end 110 of the first invalid portion 11 is disposed above the center portion 601 of the heater at a distance exceeding 0.25 L₁ along the moving direction, during the process of moving the glass preform 1 upwards, the porous silica glass body 5 may be imperfectly vitrified not only in the first invalid portion 11, but also in the valid portion 10. Such a case is not desirable since the yield of the optical fiber preform is thereby deteriorated.

In the present invention, it is preferable to control the moving speed of the invalid portion in the main heating region 600 to be 100 to 300 mm/minutes irrespective of the moving direction of the glass preform 1. By controlling the moving speed to be within the above-described range, it is possible to obtain a more enhanced effect of suppressing cracking, delamination, dislocation and the like in the valid portion 10.

In the above-description, the method B was explained to a case in which arrangement relative position of the glass preform and the heater in the beginning of the heating was controlled using a zone heating furnace. It is possible to use a homogeneous heating furnace to perform the heat treatment, and control the arrangement of the glass preform in the homogeneous heating furnace, where the homogeneous heating furnace that can heat a whole body of an object of heating without moving the object.

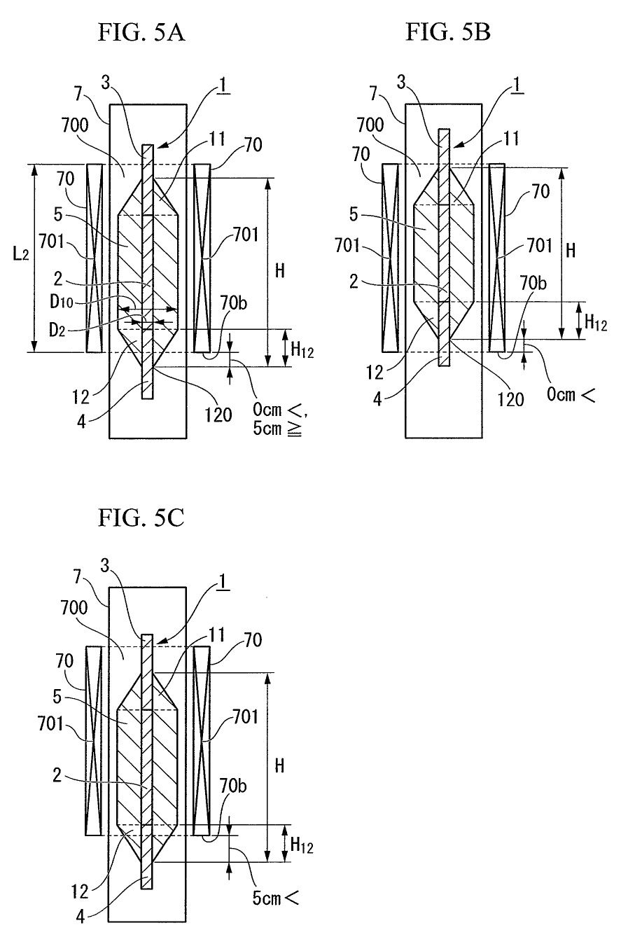

In the present embodiment, it is preferable to arrange the tip end of the invalid portion to be projecting at a length of longer than 0 cm and not longer than 5 cm along the axial direction of the glass rod from the end of the heater in the beginning of heating the glass preform. Where the projecting length of the invalid portion is substantially within the above-described range, it is possible to obtain a sufficient effect for the glass preform generally used. It is further preferable to control the projecting length of the invalid portion in accordance with the length of the invalid portion along the axial direction of the invalid portion. It is preferable to control the above-described projecting length to be 0 to 30% of the length of the invalid portion. FIG. 5 shows an example of such an arrangement. FIG. 5 is a schematic cross section showing an arrangement of the glass preform in the homogeneous heating furnace 7 in the beginning of the heating.

As exemplified by the figure, a heater 70 is placed in the homogenous heating furnace so as to surround a predetermined region, and the region surrounded by the heater 70 constitutes a main heating region 700. L2 denotes the length of the heater 70 along the axial direction of the glass rod 2. The glass preform 1 is disposed in the main heating region 700. H denotes a length of the porous silica glass body 5 of the glass preform along its axial direction.

In the present embodiment, it is preferable to arrange the tip end 120 of the second invalid portion 12 to be projected with a projecting length of longer than 0 cm and not longer than 5 cm along the axial direction of the glass rod 2 from the lower end 70b of the heater 70. As an example of such an arrangement, FIG. 5A shows a case in which the length of the projecting portion of the tip end 120 is not 0 (for example, larger than 0 and not larger than 0.3H₁₂).

When a heating of the glass rod 1 is started at that state, the porous silica glass body in the second invalid portion is mainly heated from its surface, and is gradually vitrified to a transparent glass from the surface in the inner radial direction. Along the axial direction of the glass rod 2, the main heating region 700 heated by the heater 70 has a thermal distribution such that temperature decreases with increasing distance from its center portion 701. Where the tip end 120 is projected from the lower end 70b of the heater 70, the arranged position of the tip end 120 is outside the main heating region 700. Therefore, the second invalid portion 12 is totally vitrified to a transparent glass after the valid portion 10. Therefore, as in the case of using a zone heating furnace, at least a portion of the porous silica glass body 5 is dislocated compared to the position of the second dummy rod in the second invalid portion. By this dislocation, stress is relaxed.

By thus generating a relaxation of stress, it is possible to control cracking, delamination, dislocation or the like of the glass in the invalid portion.

On the other hand, where the tip end 120 of the second invalid portion 12 is placed at a higher position than the lower end 70b of the heater as shown in FIG. 5B, the porous silica glass body 5 may be heated not only from its surface but also from the tip end 120. Further, the time from a completion of total vitrification of the valid-portion 10 to the completion of total vitrification of the second invalid portion 12. Therefore, as in the case of using a zone heating furnace, it is difficult to dislocate the porous silica glass body compared with the second dummy rod 4 in the second invalid portion 12.

Where, as shown in FIG. 5C, the tip end 120 of the second invalid portion is disposed with a projection length exceeding 5 cm (for example, 0.3H₁₂) from the lower end 70b of the heater, there is a possibility of incomplete vitrification of the porous silica glass body 5 to a transparent glass not only in the second invalid portion 12 but also in the valid portion 10.

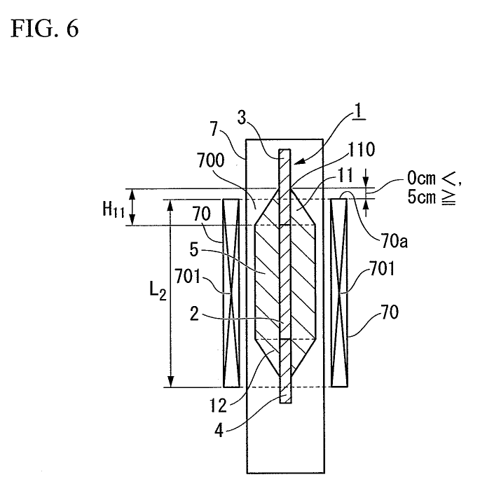

While a case of controlling an arrangement of the tip end 120 of the second invalid portion 12 was explained above with reference to FIG. 5, the stress may be relaxed in accordance with a similar manner by controlling an arrangement of the tip end 110 of the first invalid portion 11 as shown in FIG. 6.

FIG. 6 is a schematic cross sectional diagram that exemplifies an arrangement of the glass preform 1 in a homogeneous heating furnace 7.

Where the arrangement of the tip end 110 is controlled, it is preferable to arrange the tip end 110 to be projecting from the upper end 70a of the heater with a projection length of longer than 0 cm and not longer than 5 cm along the axial direction of the glass rod 2. As an example of such an arrangement, FIG. 6 shows a state in which projection length of the tip end 110 is not 0 (for example, the case in which the projection length is longer than 0 and not longer than 0.3H₁₁).

When the heating of the glass preform 1 is started from this state, the porous silica glass body 5 is mainly heated from its surface in the first invalid portion 11. As a result, the porous silica glass body 5 is gradually vitrified to a transparent glass from its surface in the inner radial direction. In a similar manner as explained in the above-described case, vitrification of the first invalid portion 11 is completed after the completion of the vitrification of the valid portion, due to a thermal gradient of the main heating region 700 heated by the heater 70, or by a projecting arrangement of the tip end portion 11 departing from the main heating region 700.

As a result, as in the case of second invalid portion 12, a position of at least a portion of the porous silica glass body 5 is dislocated compared with the first dummy rod 3 in the first invalid portion 11, and the stress is relaxed.

On the other hand, where a tip end 110 of the first invalid portion 11 is arranged lower than the upper end 70a of the heater 70 (not shown by a figure), the porous silica glass body 5 may be heated from its tip end 110 not only from its surface. Further, the duration from the completion of vitrification of the whole valid portion 10 to the completion of vitrification of the whole invalid portion 11 is shortened. Therefore, as in the case of the second invalid portion 12, it is difficult to cause a dislocation of a position of the porous silica glass body 5 relative to the position of the first dummy rod 3 in the first invalid portion.

Where the tip end 110 of the first invalid portion 11 is disposed projecting from the upper end 70a of the heater 70 at a projection length of 5 cm (for example, 0.3H11) from the upper end 70a of the heater 70a, there is a possibility of incomplete vitrification of the porous silica glass body 5 to a transparent glass not only in the first invalid portion 11 but also in the valid portion 10.

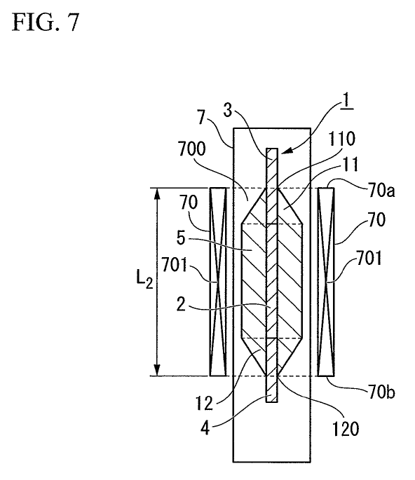

In the present embodiment, position of only one tip end of the glass preform selected from the tip end 110 and the tip end 120 may be arranged as described above. So as to obtain an more satisfactory optical fiber preform, it is preferable to control the arrangements of both of the tip end 110 and the tip end 120 as described above. As an example of such an arrangement, FIG. 7 shows a state in which a tip end 110 is arranged at a same height as the upper end 70a of the heater 70, and the tip end 120 is arranged at the same height as the lower end 70b of the heater 70.

In the present invention, the glass preform to be subjected to a heat treatment, especially to a heat treatment using a homogeneous heating furnace preferably has the below described dimension. The silica glass porous boy 5 shown in FIG. 1 preferably has a length H of 1900 mm or less along its axial direction. Along the axial direction, each of the length H₁₁ of the first invalid portion 11 and the length H₁₂ of the second invalid portion 12 is preferably 250 mm or less. The length H₁₀ of the valid portion along the same direction is preferably 1400 mm or less. A diameter D₁₀ of the valid portion 10 is preferably 200 to 400 mm. A diameter D₂ of the glass rod 2 is preferably 30 to 50 mm.

In the method A as well as in the method B of the present invention, it is preferable to control the dimension c of dislocation of the porous silica glass body in the first invalid portion and/or in the second invalid portion to be in the range defined by 0.5b/a≦c≦5b/a, where a is a length (taper length) of the tapered portion along the axial direction, and b is a diameter of a glass rod in the valid portion. For example, the glass preform 1 and the optical fiber preform 91 exemplified by FIG. 1 and FIG. 2 preferably satisfy a relationship defined by 0.5D₂/H₁₁≦ΔX₁≦5D₂/H₁₁ and 0.5D₂/H₁₂≦ΔX₁≦5D₂/H₁₁. When the dimension of dislocation in the invalid portion is in the above-described range, adhesion is easily controlled in the method A. In addition, in method A and in method B, it is possible to relax the stress further effectively without deteriorating a productivity of an optical fiber preform.

The present invention was carried out by the finding that cracking, delamination, dislocation or the like of the glass in the valid portion could be suppressed by changing a relative position of the porous silica glass body and the glass rod at their interface in the invalid portion. Further, the present invention was completed by finding the preferable conditions for changing the relative position as described above. As a result, according to the present invention, it is possible to provide an optical fiber preform of a high quality. In addition, the present invention may be applied for a production of a large sized optical fiber preform. Since a conventional production appliance may be used for the method of the present invention, the present invention can be generally applied. Therefore, it is possible to provide a high-quality optical fiber prefrom inexpensively. The present invention can be used in the fields of optical communication, optical fibers, optical amplifiers or the like.

### EXAMPLE

The present invention is explained in more detail with reference to a specific example. While, it should be noted that the present invention is not limited to the below described example.

### Example 1

Firstly, a glass rod for a core of the valid portion was prepared.

A germanium-doped core preform (a core preform made of germanium-doped silica glass) was produced in accordance with the VAD method. The core preform was formed to have a core portion and a thin clad portion having a refractive index equivalent to that of pure silica glass. Relative refractive index difference of the core portion relative to the clad was Δ0.33%, and the core preform was given a step index profile. The core preform was drawn to a glass rod for a core having a length of 1200 mm along the axial direction and a diameter of 35 mm.

Two dummy rods having a diameter of 42 mm were fused to the both ends of the glass rod for a core. The thus obtained glass rod is hereinafter referred to as a glass rod.

Fine glass particles (soot) were deposited on the periphery of the glass rod to constitute a porous glass preform. The fine glass particles were generated by hydrolysis and oxidation of SiCl₄ gas using an oxyhydrogen flame burner. The portion lying between the two fusion-bonded boundaries of the glass rod for a core and dummy rods were formed to a valid portion. Invalid portions were formed to have a porous silica glass body tapered from the fusion bond boundary towards the tip of the dummy rod. The length of the tapered portion was about 100 mm in each of invalid portions. The diameter of the valid portion was 280 mm.

The thus obtained glass preform was heat treated in a zone heating furnace as shown in FIG. 3A, where the heater had a length of 200 mm along the moving direction of the glass preform. At that time, the glass preform was disposed such that the position of the tip end of the second invalid portion was coincident with the center position (half-length position) of the heater, and the heating was started from that state. Subsequently, a whole of the porous silica glass body was vitrified to a transparent glass by lifting down the glass preform. The speed of the second invalid portion passing through the main heating region was controlled to be 200 mm/minute. The thus obtained optical fiber preform had a diameter of the valid portion of 130 mm. The effective fiber length was about 1300 kmc (km core).

In the present example, the porous silica glass body was vitrified from its surface in the second invalid portion. Before the vitrification of the radially innermost portion (vicinity to the interface with the dummy rod) of the porous silica glass body, the end of porous silica glass body in the invalid portion was dislocated by 2 cm along the axial direction of the glass preform compared with the dummy rod. As a result, cracking, delamination, dislocation or the like were not generated in the valid portion.

### Example 2

A glass rod for a core was prepared by using the germanium doped core preform as shown in the Example 1 and drawing the core preform to have a dimension of 1100 mm in axial length and 40 mm in diameter. Dummy rods of 45 mm in diameter were fusion-bonded to both ends of the core glass rod. Fine glass particles (soot) were deposited using an OVD method to constitute a porous glass preform having the porous glass body to be worked to a clad layer. The porous glass body was formed by depositing a plurality of soot layers. The fine glass particles were generated by hydrolysis and oxidation of SiCl₄ gas using an oxyhydrogen flame burner. The portion lying between the two fusion-bonded boundaries of the glass rod for a core and dummy rods were formed in a valid portion. Invalid portions were formed to have a porous silica glass body tapered from the fusion bond boundary towards the tip of the dummy rod. The length of the tapered portion was about 150 mm in each of the invalid portions. The diameter of the valid portion was 300 mm. In the invalid portions, only a first soot layer was deposited at a temperature of 10° C. lower than the valid portion. After that, another soot layers were deposited at a normal temperature.

The thus obtained glass preform was heat treated in a zone heating furnace used in Example 1. At that time, as shown in FIG. 4, the glass preform was firstly disposed such that a position of an end of the first invalid portion was 50 mm (0.25 times the length of the heater of 200 mm) higher than the center of the heater along the moving direction of the glass preform, and the heating was started from that state. After that, by heating the glass preform while lifting up the glass preform, a whole of the porous silica glass body was vitrified to a transparent glass. At that time, the speed of the first invalid portion passing through the main heating region was 150 mm/minutes. A diameter of the thus obtained optical fiber preform was 150 mm, and an effective fiber length was 1700 kmc.

In the present example, after the vitrification of the surface of the porous silica glass body in the first invalid portion and before the vitrification of the radially portion (a portion in the vicinity to the interface of the porous silica glass body and the dummy rod) of the porous silica glass body, the tip end of the porous silica glass body in the invalid portion was dislocated with a slip length of 3 cm along the axial direction relative to the dummy rod. As a result, cracking, delamination, dislocation or the like were not generated in the valid portion.

### Example 3

A glass rod for a core was prepared using the germanium doped core preform as used in Example 1 and drawing the core preform to a glass rod having an axial length of 1000 mm and a diameter of 44 mm. The thus formed glass rod was used as a glass rod for a core in the valid portion. Two dummy rods each having a diameter of 50 mm were respectively fusion-bonded to both ends of the glass rod for a core. A porous glass preform was formed by depositing a porous silica glass body constituted of fine silica glass particles (soot) on the periphery of the thus obtained glass rod using an OVD method. The porous glass body was formed by depositing a plurality of soot layers. The fine glass particles were generated by hydrolysis and oxidation of SiCl₄ gas using an oxyhydrogen flame burner. The portion lying between the two fusion-bonded boundaries of the glass rod for a core and dummy rods were formed to a valid portion. Invalid portions were formed to have a porous silica glass body tapered from the fusion bond boundary towards the tip of the dummy rod. The length of the tapered portion was about 200 mm in each of invalid portions. The diameter of the valid portion was 330 mm. In the invalid portions, only a first soot layer was deposited at a temperature of 50° C. lower than the valid portion. After that, other soot layers were deposited at a normal temperature.

The thus obtained porous glass preform was heat treated in a homogeneous heating furnace as shown in FIG. 5A. At that time, the glass preform was disposed such that a tip end of the second invalid portion projected with a projection length of 50 mm from the lower end of the heater in the homogeneous heating furnace. A whole of the porous silica glass body was vitrified by heating the glass preform at that state. The thus obtained optical fiber had a valid portion of 163 mm in diameter, and an effective fiber length was about 2000 kmc.

In the present example, the second invalid portion was totally vitrified after the vitrification of the valid portion. Therefore, by the shrinkage stress of the valid portion, the tip end of the porous silica glass body in the invalid portion dislocated with a slip length of 5 cm along the axial direction relative to the position of the dummy rod. As a result, cracking, delamination, dislocation or the like were not generated in the valid portion.

### Experiment 1

The valid portion of each of the optical fiber preforms 1 to 3 were drawn to an optical fiber.

As a result, the diameter of each optical fiber was stably within a range of 125±0.5 μm. These optical fibers were subjected to measurements using an optical time domain reflectometer (OTDR) in 1.55 μm band and 1.31 μm band. As a result, it was confirmed that an optical fiber of satisfactory quality was obtained in high yield without generating transmission loss step or swell.

### Comparative Example 1

A porous glass preform was prepared in a similar manner as in Example 1. As shown in FIG. 3B, the glass preform was disposed in a zone heating furnace such that the tip end of the second invalid portion was positioned 100 mm (0.5 times the length of the heater of 200 mm) higher than the center of the heater along the moving direction of the glass preform, and heating of the glass preform was started from that state. The other conditions were controlled to be similar to those of Example 1. Thus, an optical fiber preform was produced.

As a result, in the second invalid portion, the porous silica glass body was vitrified not only from its surface but also from its tip end. A substantial dislocation of the porous silica glass body was not observed in the second invalid portion. On the other hand, a spiral dislocation of about 100 mm in length was generated at the interface between the vitrified layer and the core glass rod by the effect of shrinkage stress.

### Comparative Example 2

An optical fiber preform was prepared in a similar manner as in Example 2, whereas controlled deposition temperature of the porous silica glass body and arrangement of the glass preform in the beginning of the heating were different from those in Example 2. In the preparation process of the glass preform, deposition of a first soot layer in the invalid portion was performed at the same deposition temperature as in the valid portion. In the beginning of heating in the vitrification process, the glass preform was disposed such that the position of the tip of the first invalid portion was 100 mm (0.5 times the length of the heater of 200 mm) lower than the center of the heater along the moving direction of the glass preform.

As a result, in the second invalid portion, the porous silica glass body was vitrified not only from its surface but also from its tip end. A substantial dislocation of the porous silica glass body was not observed in the second invalid portion. On the other hand, a spiral dislocation of about 200 mm in length was generated at the interface between the vitrified layer and the core glass rod by the effect of shrinkage stress.

### Comparative Example 3

An optical fiber preform was prepared in a similar manner as in Example 3, whereas the controlled deposition temperature of the porous silica glass body and arrangement of the glass preform in the beginning of the heating were different from those in Example 3.

In the preparation process of the glass preform, deposition of a first soot layer in the invalid portion was performed at the same deposition temperature as in the valid portion. In the beginning of heating in the vitrification process, the glass preform was disposed such that a position of the tip end of the first valid portion was lower than the upper end of the heater and the position of the tip end of the second invalid portion was higher than the lower end of the heater.

As a result, in the second invalid portion, the porous silica glass body was vitrified not only from its surface but also from its tip end. A substantial dislocation of the porous silica glass body was not observed in the second invalid portion. On the other hand, delamination of vitrified layer of 50 mm in length was generated at the interface between the vitrified layer and the core glass rod by the effect of shrinkage stress.

### Experiment 2

Alternating the optical fiber preforms obtained in the Examples 1 to 3, valid portions of the optical fiber preforms obtained in Comparative Examples 1 to 3 were worked to optical fibers as in the similar manner in the Experiment 1. Target value of the diameter of each optical fiber was 125 μm.

As a result, in each of the optical fiber, spike shaped abnormal morphology exceeding the range of 125±0.5 μm was observed locally in the portion corresponding to the portion of dislocation or delamination in the valid portion of the optical fiber preform. Specifically, when the optical fiber preform of Comparative Example 3 was used to draw an optical fiber, drawing was interrupted by breaking of the fiber. Therefore, it was required to remove the abnormal potion so as to obtain an optical fiber of satisfactory quality. As a result, yield of an optical fiber was deteriorated. As a result of OTDR analysis of the spike shaped portion, transmission loss step exceeding 0.1 dB was observed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A method of producing an optical fiber preform comprising:
performing production of a glass preform having a valid portion to be drawn to an optical fiber and invalid portions disposed to both ends of the valid portion by depositing a porous silica glass body on a periphery of a glass rod;
and performing vitrification of the porous silica glass body by heat treating the glass preform,
wherein, during the vitrification, at least a portion of the porous silica glass body in the invalid portion of at least one end is dislocated relative to the glass rod along the axial direction of the glass rod such that a stress between the glass rod and the porous silica glass body is relaxed.

2. The method of producing an optical fiber preform according to claim 1, wherein the dislocation of the porous silica glass body to be vitrified is performed by controlling a deposition condition of the porous silica glass body and/or vitrification condition to vitrify the porous silica glass body to a transparent glass.

3. The method of producing an optical fiber preform according to claim 2, comprising performing heat treatment of the glass preform during the vitrification by using a zone heating furnace equipped with a heater and moving the glass preform in the axial direction thereof relative to the heater, wherein in the beginning of the heat treatment, a tip portion of an invalid portion on the side of the moving direction of the glass preform is placed within 25% or less of a length of the heater from the center of the heater along the moving direction.

4. The method of producing an optical fiber preform according to claim 2, comprising performing heat treatment of the glass preform during the vitrification by using a zone heating furnace equipped with a heater and moving the glass preform in the axial direction thereof relative to the heater, wherein, in the beginning of the heat treatment, a tip portion of the invalid portion of at least one end is placed at a position projecting with a length of longer than 0 cm and not longer than 5 cm from the end of the heater in the axial direction of the glass rod.

5. The method of producing an optical fiber preform according to claim 2, wherein adhesion between the porous silica glass body and the glass rod at their interface in the invalid portion of at least one end is made smaller than the adhesion between the porous silica glass body and the glass rod at their interface in the valid portion.

6. The method of producing an optical fiber preform according to claim 5, wherein the porous silica glass body is formed by layering a plurality of soot layers, and the adhesion between the porous silica glass body and the glass rod at their interface in the invalid portion of at least one end is made smaller than the interlayer adhesion of the soot layers.

7. The method of producing an optical fiber preform according to claim 5, wherein the porous silica glass body is formed to have a normal portion having a predetermined adhesion to the glass rod and at least a low adhesion portion where the adhesion to the glass rod is smaller than that of the normal portion by decreasing the deposition temperature of the porous silica glass body at the low adhesion portion.

8. The method of producing an optical fiber preform according to claim 7, wherein a difference of the deposition temperature of the low adhesion portion from a deposition temperature of the normal portion is controlled to be −5 to −50° C.

9. The method of producing an optical fiber preform according to claim 1, wherein the porous silica glass body has a tapered shape in the invalid portion of at least one end such that outer diameter of the porous silica glass body gradually decreases along the axial direction towards the tip of the porous silica glass body.

10. The method of producing an optical fiber preform according to claim 7, wherein the porous silica glass body has a tapered shape in the invalid portion of at least one end such that outer diameter of the porous silica glass body gradually decreases along the axial direction towards the tip of the porous silica glass body.

11. The method of producing an optical fiber preform according to claim 8, wherein the porous silica glass body has a tapered shape in the invalid portion of at least one end such that outer diameter of the porous silica glass body gradually decreases along the axial direction towards the tip of the porous silica glass body.

12. The method of producing an optical fiber preform according to claim 9, wherein
a dimension c of dislocation of the porous silica glass body to be vitrified in the invalid portion is controlled to be in a range given by a formula, 0.5b/a≦c≦5b/a, where a is a length of the tapered portion along the axial direction, and b is a diameter of the glass rod in the valid portion.

13. The method of producing an optical fiber preform according to claim 10, wherein a dimension c of dislocation of the porous silica glass body to be vitrified in the invalid portion is controlled to be in a range given by a formula, 0.5b/a≦c≦5b/a, where a is a length of the tapered portion along the axial direction, and b is a diameter of the glass rod in the valid portion.

14. The method of producing an optical fiber preform according to claim 11, wherein a dimension c of dislocation of the porous silica glass body to be vitrified in the invalid portion is controlled to be in a range given by a formula, 0.5b/a≦c≦5b/a, where a is a length of the tapered portion along the axial direction, and b is a diameter of the glass rod in the valid portion.
